(19) United States
(12) Patent Application Publication
(10) Pub. No.: US 2026/0046074 A1
(43) Pub. Date: Feb. 12, 2026

(54) FRAME CONTROL IN REPLICATION NETWORKS

(71) Applicant: Cisco Technology, Inc., San Jose, CA (US)

(72) Inventors: Robert Edgar Barton, Richmond (CA); Saravanan M. Karunanidhi, Bangalore (IN); Albert H. Mitchell, San Jose, CA (US)

(21) Appl. No.: 18/798,690

(22) Filed: Aug. 8, 2024

(51) Int. Cl. H04L 1/22; H04L 1/00; H04L 12/42; H04L 47/11; H04L 47/267

(52) U.S. Cl. CPC H04L 1/22; H04L 12/42; H04L 47/11; H04L 47/267; H04L 2001/0095

(57) ABSTRACT

Disclosed are systems, apparatuses, methods, and computer-readable media for balancing replicated frames in a replication network. A method includes: receiving, at a redundancy receiver, first frames from a first path and second frames from a second path, determining a network performance imbalance between a redundancy edge device to the redundancy receiver based on receiving the first frames and the second frames, and in response to determining a threshold of memory will be exceeded based on the delay between the first frames and the second frames, providing an indication to slow frames transmitted along the second path. In some aspects, a path mismatch device is configured to track replication frames and determine network performance imbalance. For example, the path mismatch device can identify one network is slower than another, and may provide remediation to balance network performance that maintains the integrity of the replication network.

### TECHNICAL FIELD

The disclosure relates generally to cloud networking and, more specifically but not exclusively, to systems and techniques for frame control in replication networks.

### BACKGROUND

Replication networks are implemented across various industries to ensure high reliability and minimal downtime in critical systems. In industrial automation, High-availability Seamless Redundancy (HSR) is used to maintain continuous operation by providing redundant data transmission paths. Power substation networks often utilize Parallel Redundancy Protocol (PRP) to manage crucial data, enhancing communication system reliability. Telecommunication providers, financial trading systems, data centers, and cloud services all rely on replication networks to maintain service continuity, data integrity, and customer trust. Additionally, public safety communication networks and transportation control systems, such as those in aviation and railways, implement replication networks to ensure operational safety and efficiency during emergencies or network failures. These implementations highlight the importance of replication networks in maintaining consistent and reliable data flow across diverse applications.

### BRIEF DESCRIPTION OF THE DRAWINGS

In order to describe the manner in which the above-recited and other advantages and features of the disclosure may be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a block diagram of a High-availability Seamless Redundancy (HSR) network in accordance with some aspects of the disclosure;

FIG. 2 is a block diagram of a Parallel Redundancy Protocol (PRP) network in accordance with some aspects of the disclosure;

FIG. 3 is a conceptual diagram illustrating single path congestion in a replication network in accordance with some aspects of the disclosure;

FIG. 4 is a sequence diagram illustrating correction of path mismatches by a redundancy box including a path mismatch device in accordance with some aspects of the disclosure;

FIG. 5 is a sequence diagram illustrating correction of path mismatches by a redundancy box including a path mismatch engine in accordance with some aspects of the disclosure;

FIG. 6 illustrates an example method for correcting path mismatches by a redundancy box including a path mismatch device in accordance with some aspects of the disclosure;

FIG. 7 illustrates a block diagram of a system-on-chip (SoC) used in a network device to perform various functions in hardware in accordance with various aspects of the disclosure; and

FIG. 8 shows an example of a computing system, which may be for example any computing device that may implement components of the system.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described to avoid obscuring the description. References to one or an embodiment in the present disclosure may be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims, or may be learned by the practice of the principles set forth herein.

### Overview

Certain applications, such as television studios, utilities, manufacturing facilities, and other real-time control applications (e.g., real-time conferencing applications) may require a demand for ultra-low packet loss rates. The applications may include, for example, but not limited to deterministic networks, such as those used with virtual private networks and may require ultra-low packet loss rates (e.g., loss rates ranging from 10⁻⁶ to 10⁻¹² or potentially even lower).

Packet loss may be defined in two non-limiting categories: single failures and availability failures. Single failures may, for example, affect a single or only a few packets per failure event. Congestion is one cause for such single failures resulting in packet loss. Congestion may occur on wired networks when a forwarding node (bridge, router, or other non-limiting network device) lacks sufficient buffer memory space to accommodate a received packet for subsequent forwarding. When the network device lacks such buffer space, the received packet may have to be dropped and does not continue on the path to the desired destination.

In such a wired network scenario, the transmission rate may be limited by any number of random events. Random events may occur in the medium or the forwarding devices themselves and include, for example, cosmic rays, power fluctuations, electromagnetic interference, and other rate-limiting events.

Alternatively, availability failures may occur when there is a failure of a network device (node), an individual component of the network device, or a failure of the transmission medium itself that may render the particular network device unable to forward packets. Depending on the severity of the availability failure, the network device may be unable to forward packets from a period consisting of a matter of seconds to a matter of days or more.

As described herein, the availability and single failure that are described are non-limiting examples, and failures at intermediate rates are also possible. For example, failures at intermediate rates may be handled in some embodiments by various heuristics that can identify excessive single failures, and in some cases subsequently trigger a purposeful availability failure.

Approaches to achieve ultra-low packet loss may include the concept of simple multipathing. In simple multipathing, the same data packet traveling to a destination is sent on more than one path from the source to the destination. Ideally, the multipathing may send the same packet (original and replicated) on separate paths on a near-simultaneous manner. Extra copies of the packet received at the destination may be subsequently discarded. In various embodiments, a network forwarding device located near the source of the packet may be responsible for replicating packets to be sent to the destination. Similarly, a network device located near the destination may be responsible for deleting received duplicate packets.

A replication network is a network designed to ensure data redundancy and availability by copying and maintaining data across multiple parallel paths in different nodes. Based on the duplicate paths, a replication network enhances data reliability, fault tolerance, and disaster recovery capabilities by synchronizing replicas of data transmitted along each path. In the event of a failure or data loss at a single node, the replication network allows access to the same data from a different network, minimizing downtime and ensuring continuous operation. Replication networks are used for applications that cannot withstand packet loss such as utility applications (e.g., electrical grid, water, etc.), industrial applications (e.g., factory automation), transportation systems (e.g., rail systems, autonomous driving, etc.), health systems, and so forth.

One type of replication network is a Parallel Redundancy Protocol (PRP) network, which uses Ethernet connections that provide seamless failover against failure of any network component. A PRP uses multiple local area networks (LANS) to duplicate traffic along independent paths to ensure fault tolerance. A PRP includes

Another type of replication network is High-availability Seamless Redundancy (HSR) network. An HSR network consists of a ring topology using dual attached nodes. Frames are sent in both directions along the ring, and removed at different nodes along the rings once determined that the frame has been successfully forwarded to the destination outside of the ring.

In the case of high-speed streams (i.e. real-time applications), the duplicate replication frame elimination function requires detailed history keeping, adding another undesired level of complexity to the design of each network device. The use of the stream sequence numbers may make it very difficult to create a solution that works for paths which are both bridged and routed, by requiring an L2 tag with information that does not get routed and an L3 encapsulation of that same information which is not easily visible to bridge devices.

Replication networks may use a supervisor frame which is a specific type of data frame to control and supervise functions in the replication, often related to signaling, train control systems, and other critical operations. Supervisor frames are used to monitor the health and status of the replication network and carry information about the operational status of each node and the integrity of the network links, as well as the configuration of the network (e.g., joining the replication network). Supervisor frames also provide redundancy management of the duplicate path by ensuring both paths are actively being used and checked, as well as detect errors in the network, such as lost or corrupted frames. Supervisor frames may also provide status information about each node in the network such as an operational state of each node, any detected faults, synchronization information, and path verification. Supervisor frames also ensure that each node is aware of the network configuration and are used in adding new nodes, removing faulty ones, and updating the network map as changes occur. In some cases, the supervisor frame also ensures synchronization across the network to maintain data integrity and communication consistency.

A frame and a packet are both units of data transmission in computer networks, but they operate at different layers of the OSI model. A frame exists at the Data Link layer (Layer 2) and includes the payload data and also headers and trailers that contain control information such as error checking and the physical addresses of the source and destination devices. In contrast, a packet exists at the Network layer (Layer 3) and contains the payload along with a header that includes logical addressing information, such as IP addresses, which facilitates routing the data across different networks. Frames are transmitted of a physical link (e.g., a local area network (LAN) segment) whereas packets are transmitted within the frames. Frames are used for data transmission within local network segments, packets are used to route data between different network segments, enabling communication across larger and interconnected networks.

In a replication network, nodes must manage the replicated frames effectively to avoid issues such as frame loss or sequence number wraparound, which can lead to frame ambiguity and reordering problems. Excessive delays or congestion can exhaust memory capacity in the redundancy box, causing potential frame loss and wraparound issues in replication networks.

Systems, apparatuses, processes (also referred to as methods), and computer-readable media (collectively referred to as “systems and techniques”) are described herein for detecting and remediating congestion in a replication network. In some aspects, a path mismatch device is configured to track replication frames and determine network performance imbalance. For example, the path mismatch device can identify one network is slower than another, and may provide remediation to balance network performance that maintains the integrity of the replication network.

An example method includes receiving, at a redundancy receiver, first frames from a first path and second frames from a second path, determining a network performance imbalance between a redundancy edge device to the redundancy receiver based on receiving the first frames and the second frames, and in response to determining a threshold of memory will be exceeded based on the delay between the first frames and the second frames, providing an indication to slow frames transmitted along the second path.

In some aspects describe below, the path mismatch device may use explicit signaling to request transmission control from a device. In another aspect, the path mismatch device may use implicit signaling to cause another device to request transmission control.

Various aspects of the application will be described with respect to the figures.

### Example Embodiments

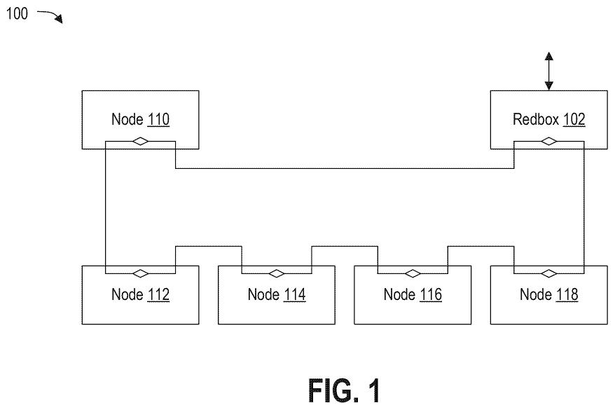

FIG. 1 is a block diagram of an HSR network 100 in accordance with some aspects of the disclosure. The HSR network 100 includes a redundancy box 102 (e.g., redbox) that is configured to handle supervisor frames and transmission of replicated data across a ring formed by the redundancy box 102 and node 110, node 112, node 114, node 116, and node 118. In this case, each node is dual attached to form a ring topology. In the event a frame is received by the redundancy box 102, the redundancy box 102 transmits replication frames on both network interfaces in the clockwise direction and the counterclockwise direction. Replication frames have a sequence identifier (e.g., a 16-bit value) to identify the frame. In the event a node is unavailable or otherwise slow, the replication frame will continue to have a low latency link to the destination. For example, in the event that a network link to the node 110 is congested or temporarily slow, a replication frame transmitted in the counterclockwise direction may be delayed. However, a replication frame transmitted by the redundancy box 102 in the clockwise direction can still reach node 112 irrespective of the path in the counterclockwise direction.

Once a replication frame is received by the destination node (e.g., node 112), the node 112 must maintain some type of infrastructure to handle the replication frame in the counterclockwise direction. In an HSR network, there are different methods to configure addressing the replication frame, such as sending an instruction to node 110 to drop the replicated frame. However, the node 110 must track the replication frames not received by node 112. Because Layer 2 operates at the hardware level, memory is limited and the link between redundancy box 102 and node 110 is unavailable for a long period of time (e.g., 10 seconds), the node 110 may have to drop replicated frame information and the sequence number may have wrapped around (e.g., starts over when a maximum number is reached) at the redundancy box 102, which can cause a reordering problem, which can cause frames to be dropped due to an ambiguity in the replicated frames.

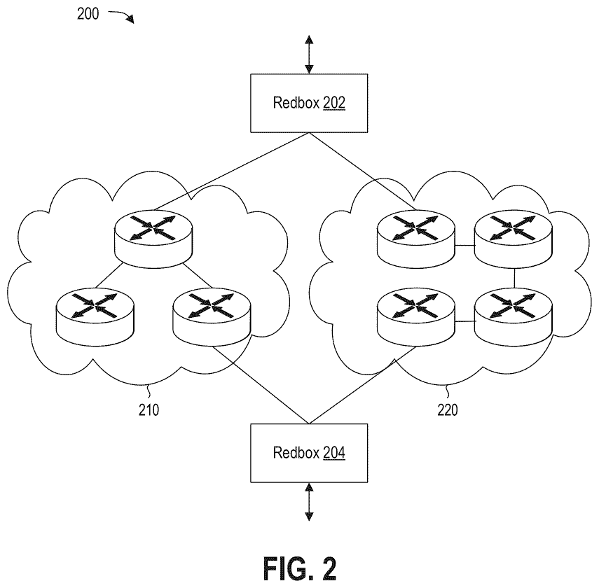

FIG. 2 is a block diagram of a PRP network 200 in accordance with some aspects of the disclosure. The PRP network 200 has a different topology than an HSR network (e.g., the HSR network 100 in FIG. 1) and includes a first redundancy box 202 and a second redundancy box 204. The first redundancy box 202 and the second redundancy box 204 are attached via redundant networks that can have different network topologies. For example, the second redundancy box 204 and the second redundancy box 204 are connected via a first network 210 and a second network 220.

The first network 210 and the second network 220 have different topologies and implementations, different ingress and egress points, and many different factors that make performance different. For example, the first network 210 has two node hops from the first redundancy box 202 to the second redundancy box 204, and the second network 220 has four node hops from the first redundancy box 202 to the second redundancy box 204. In this case, presuming at the network equipment and structure of the first network 210 and the second network 220 are similar, the first network 210 should have lower latency than the second network 220. However, the second network 220 may have an optimized structure, more modern equipment and configurations, and other differences that may decrease the latency and jitter through the second network 220.

In the event that the second redundancy box 204 is configured to perform deduplication of replicated frames provided from the first network 210 and the second network 220, the second redundancy box 204 tracks the different frames and ensures that both replicated frames are received. For example, if a replicated frame is received via the first network 210 and is not received via the second network 220, a link in the second network 220 may have failed. However, as the first network 210 and the second network 220 have different topologies, one of the networks may be slower and the second redundancy box 204 will need to buffer replicated frames that have not yet been received from the duplicate path. When both replicated frames are received, the frame can be forwarded from the second redundancy box 204.

The second redundancy box 204 therefore also has to track a last deduplicated frame and maintain replicated frames that are not yet received from the duplicate path. In the event that the second network 220 experiences a significant delay, such as a brownout that causes significant congestion in a particular link or node, the replicated frames from the second network 220 can be delayed. As the second redundancy box 204 needs to buffer all replicated frames that have not yet been deduplicated, in some cases, the second redundancy box 204 may exhaust its memory capacity since the frames and corresponding operations are performed in hardware. For example, the sequence number can wraparound and begin again, and as the second redundancy box 204 has dropped replicated frames, may cause frame loss.

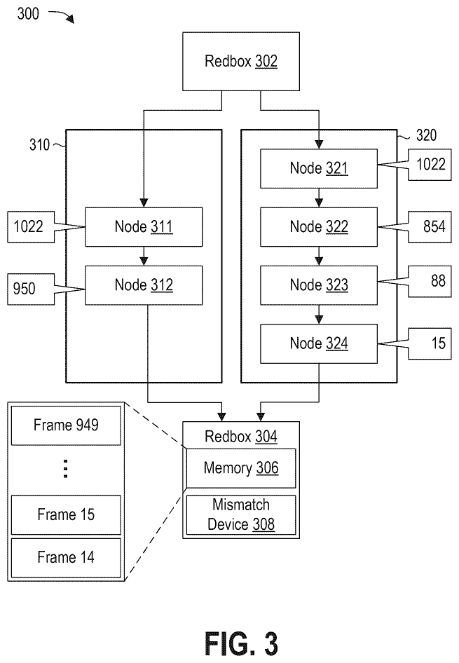

FIG. 3 is a conceptual diagram illustrating path congestion in a replication network 300 in accordance with some aspects of the disclosure. The replication network 300 includes a first redundancy box 302 and a second redundancy box 304 transmitting along two different networks. For example, the first network 310 includes a first node 311 and a second node 312, and the second network 320 includes nodes 321 to 324.

In this example, an illustration of the replication network 300 is shown a specific point in time, along with a conceptual illustration of the memory 306 of the second redundancy box 304. The first redundancy box 302 is transmitting frames through the first network 310 and the second network 320, and the second network 320 is congested due to various reasons. In this case, node 311 is transmitting a replicated frame having a sequence number of 1022 and node 311 is transmitting a frame having a sequence number of 949 to the second redundancy box 304. The node 321 is transmitting a replicated frame having a sequence number of 1022 (e.g. the same replicated frame as node 311) to node 322, node 322 is transmitting a replicated frame having a sequence number 854 to node 323, node 323 is transmitting a replicated frame having a sequence number of 88 to node 324, and node 324 is transmitting a replicated frame having a sequence number of 15.

In this example, the second redundancy box 304 has deduplicated frames 0 to 14, has received replicated frames 14 to 949 from the first network 310, and may have forwarded the replicated frames. The second redundancy box 304 may forward the replicated frames on reception, or may be configured to require reception of both replicated frames to ensure the integrity of the network. The second redundancy box 304 is therefore waiting on replicated frames 15 to 949 from the second network 320. Because frames are being received from the first network 310 at a greater rate than the second network 320, the second redundancy box 304 may run out of memory and may need to discard frames or sequence numbers of frames. In that case, when the second network 320 catches up, the sequence number may have wrapped around and started over. For example, if the sequence number supports 8 bits, then the second redundancy box 304 may start receiving replicated frames that have the same sequence number but different content from the second network 320.

In some aspects, the second redundancy box 304 may be configured to execute a path mismatch device 308 to identify and remediate network performance mismatches. The path mismatch device 308 includes a supervisory capability that tracks speed variation and mismatches between the first network 310 and the second network 320. For example, the path mismatch device 308 is configured to keep track of the memory consumption of the incoming frame sequence numbers on the first network 310 and the second network 320. In this case, the path mismatch device 308 continually tracks how many replicated frames are unaccounted for on the first network 310 and the second network 320 and determines if the memory consumed by replicated frames in the buffer (e.g., memory) exceeds the maximum threshold of memory space. The path mismatch device 308 is configured to know the memory limits and how many frame sequence numbers can be tracked before losing the memory of frames that have already been forwarded to the receiving device.

The path mismatch device 308 is configured to continually monitor the number of unaccounted frames and the missing frames as a function of time (e.g., as a time series). In some cases, the mismatch remains constant (e.g., there may be a constant 100 ms mismatch of the speed between the first network 310 and the second network 320), which indicates the number of unaccounted frames is constant. In other cases, the mismatch may vary over time due to network congestion issues on either network. In either case, the path mismatch device 308 will take action to reduce the mismatch as much as possible and may proactively try to correct the speed mismatch if the network performance is trending in different directions. As described below, a first network 310 and the second network 320 are described as separate networks, but may also be separate network paths. For example, the first network 310 (or any other networks described below) and be a first direction around a ring network and the second network 320 (or any other networks described below) can be a second direction around the ring network.

For example, the path mismatch device 308 may be configured to throttle transmission of the first redundancy box 302 based on a memory consumption consumed by replicated frames that are buffered by the second redundancy box 304 from one of the first network 310 and the second network 320. The path mismatch device 308 may provide explicit signaling to the first redundancy box 302. For example, the first redundancy box 302 may be able to send a supervisor frame to the first redundancy box 302 to provide instructions to throttle replication of frames along the first network 310. The first redundancy box 302 may buffer frames for transmission on the faster network (e.g., the first network 310 or the second network 320) to achieve transmission symmetry on both networks. For example, the signal may include network performance information associated with the first network 310 that includes a requested delay.

In another aspect, the path mismatch device 308 may be configured to provide implicit signaling to the first redundancy box 302. For example, the first redundancy box 302 may insert a congestion control into a packet in a frame. In this example, when the packet is received at a destination device, the destination device can report congestion within the network. In this example, the second redundancy box 304 induces the destination device to trigger the source device (that is transmitting to the first redundancy box 302) to reduce frame transmission, thereby slowing the transmission of replicated frames from the first redundancy box 302.

In one aspect, the path mismatch device 308 monitors the speed mismatch between the first network 310 and the second network 320 and accounts for the case that the second redundancy box 304 might receive frames from different sources based on different paths within the network, thereby having differing delays. The path mismatch device 308 is configured to monitor the delay as a function of time for each source. In some examples, the path mismatch device 308 may include predictive functionality that uses a rate of change of the network performance (e.g., jitter) and predicts a memory threshold violation based on the jitter over a period of time. In this case, the predictions may forecast issues in advance and reduce the possibility of the second redundancy box 304 losing track of replicated frames.

The path mismatch device 308 can be configured as a hardware component, such as a functional programmable gate array (FPGA) or an application specific integrated circuit (ASIC). For example, the path mismatch device 308 can be designed using a hardware description language such as Very High-Speed Integrated Circuit (VHSIC) hardware description language (VHDL) or Verilog in accordance with some aspects of the disclosure.

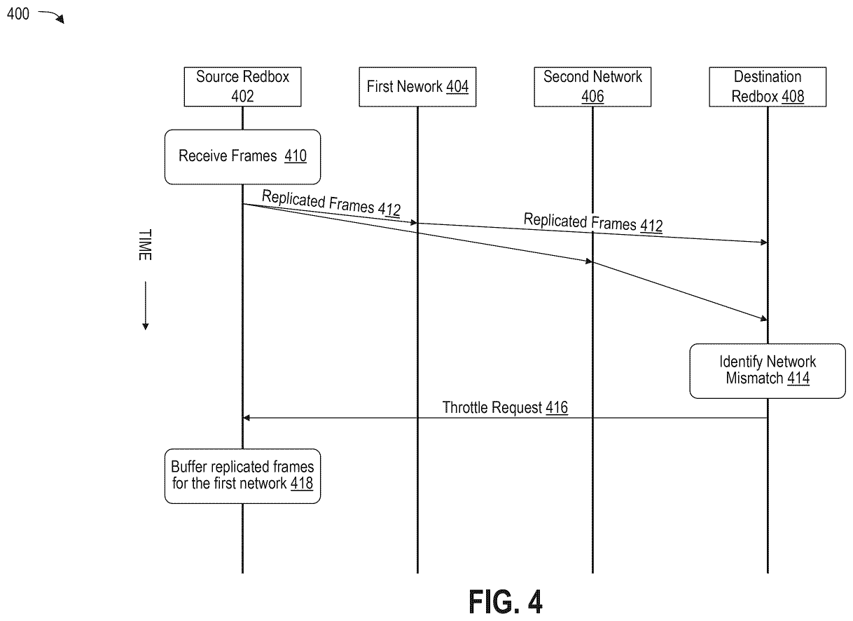

FIG. 4 is a sequence diagram 400 illustrating correction of path mismatches by a redundancy box including a path mismatch device in accordance with some aspects of the disclosure. The sequence diagram 400 includes a source redundancy box 402, a first network 404 (e.g., first set of network nodes), a second network 406 (e.g., a second set of network nodes), and a destination redundancy box 408. In some cases, the source redundancy box 402 may be referred to as a redundancy edge box and the first network 404 may be referred to as a redundancy box or redbox.

Initially, the source redundancy box 402 receives frames from a source device (not shown) at block 410. The source redundancy box 402 replicates the frames and inserts a sequence number into the replicated frames. The sequence number may be a counter or some other identifier that configures an order of the frames. The source redundancy box 402 may also include information that identifies a path (e.g., the first network 404 or the second network 406) in the replicated frame. In some cases, the path can be omitted and inferred, such as based on a modulus operation of the sequence number. The source redundancy box 402 transmits the replicated frames 412 to the destination redundancy box 408 through the first network 404 and the second network 406.

The sequence diagram 400 presumes that the second network 406 is a slower network for convenience, which is illustrated based on increasing time along the vertical axis. As the replicated frames are received by the destination redundancy box 408, the path mismatch device of the destination redundancy box 408 may identify a network path mismatch based on frames from the first network 404 and the second network 406 at block 414. For example, the replicated frames 412 may be delayed, which can cause the memory capacity of the destination redundancy box 408 to be full, which will cause the destination redundancy box 408 to drop frames.

In one example, the path mismatch device of the destination redundancy box 408 may determine that a threshold of a memory (e.g., within an ASIC or FPGA) to prevent replicated frames from being dropped. For example, the memory 306 in FIG. 3 may be 70% full. In another example, the path mismatch device of destination redundancy box 408 may identify the speed and jitter of the first network 404 and the second network 406, and then forecast that the memory will be 100% consumed within 60 seconds.

In response to the identification of the network mismatch at block 414, the path mismatch device of destination redundancy box 408 is configured to transmit a throttle request 416 to the source redundancy box 402. For example, the throttle request 416 may be a supervisor frame and may include various information, such as the speed and the jitter of the first network 404 and the second network 406. The throttle request 416 may also include a duration to buffer the replicated frames 412 before transmission on the first network 404. In some cases, the throttle request 416 may be much simpler such as a ternary information (−1, 0, 1) indicating decrease (e.g., −1), maintain (e.g., 0), or increase (e.g., 1), or a binary information (increase or decrease).

At block 418, the source redundancy box 402 is configured to throttle transmission of the replicated frames 412 to enable the replicated frames 412 transmitted in the second network 406 to catch up with the first network 404. In this case, the destination redundancy box 408 provides explicit signaling to identify the network mismatch. After block 418, the replicated frames 412 transmitted on the second network 406 should catch up. However, the path mismatch device of destination redundancy box 408 continually monitors both the first network 404 and the second network 406 to attempt to balance transmission such that maximum throughput is maintained.

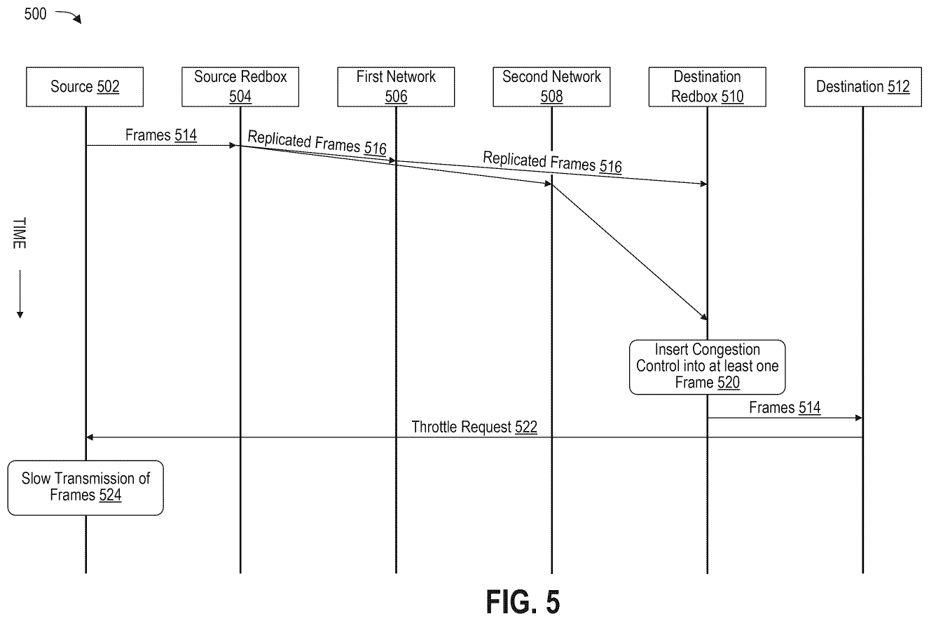

FIG. 5 is a sequence diagram 500 illustrating correction of path mismatches by a redundancy box including a path mismatch device in accordance with some aspects of the disclosure. The sequence diagram 500 includes a source device 502 that transmits frames, a source redundancy box 504 (e.g., redundancy edge box), a first network 506 (e.g., first set of network nodes), a second network 508 (e.g., a second set of network nodes), a destination redundancy device 510 (e.g., redbox), and a destination 512.

Initially, the source device 502 provides frames 514 to the source redundancy box 504 for transmission through a replicated network to the destination 512. The source redundancy box 504 replicates the frames and inserts a sequence number into the replicated frames 516. The sequence number may be a counter or some other identifier that configures an order of the frames. The source redundancy box 504 may also include information that identifies a path (e.g., the first network 506 or the second network 508) in the replicated frame. The source redundancy box 504 transmits replicated frames 516 to the destination redundancy device 510 through the first network 506 and the second network 508 The sequence diagram 500 presumes that the second network 508 is a slower network for convenience, which is illustrated based on increasing time along the vertical axis. As the replicated frames 516 are received by the destination redundancy device 510, the path mismatch device of the destination redundancy device 510 may identify a network path mismatch based on frames from the first network 506 and the second network 508 at block 520. In this example, the path mismatch device of destination redundancy device 510 may identify the speed and jitter of the first network 506 and the second network 508 and then predict that the memory will be 100% consumed within 120 seconds.

At block 520, the destination redundancy device 510 is configured to insert a congestion control into at least one frame of the replicated frames 516. In one example, the destination redundancy device 510 may be configured to invoke a deep packet inspection to modify a header of a packet within a frame. In some cases, the deep packet inspection may require a software interrupt to mutate the packet within the software layer. However, in some situations, a hardware accelerator, an ASIC, or an FPGA can perform this change.

In one example, Low Latency, Low Loss, Scalable Throughput (L4S) is a set of emerging enhancements for Layer 3 (e.g. packets) to reduce latency while maintaining low packet loss and scalable throughput. L4S includes an explicit congestion notification (ECN) field to signal congestion without dropping packets and marks packets instead of dropping them when the network is congested.

After inserting a congestion control (e.g., via the ECN field) into the frames 514 at block 520, the destination redundancy device 510 transmits the frames 514 to the destination 512. The destination 512 is configured to receive the frames to retrieve the packets and may identify at least one packet including an ECN field that indicates congestion. In this case, the destination 512 may send a throttle request 522 to the source device 502 to cause the source device 502 to slow the transmission of frames at block 524. In this example, the destination redundancy device 510 provides implicit signaling based on modifying at least one frame to include a congestion control.

In another aspect, the destination redundancy device 510 may also be configured to provide an explicit signal to the source device 502. For example, the destination redundancy device 510 may send a packet including a L4S ECN message to the source device 502 requesting to slow down the transmission.

In either case, the source device 502 slows transmission of frames at block 524 to allow the replicated frames 516 transmitted on the first network 506 and the second network 508 to be more balanced to preserve the integrity of data transmission.

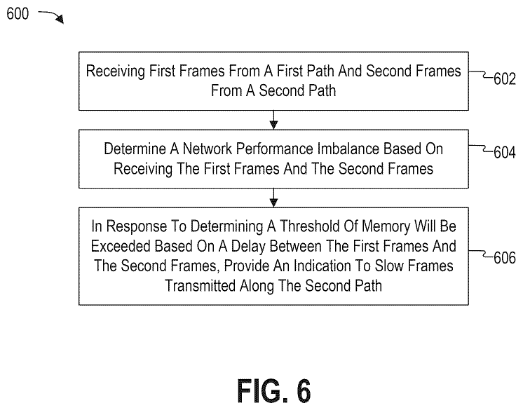

FIG. 6 illustrates an example method for correcting path mismatches by a redundancy box including a path mismatch device in accordance with some aspects of the disclosure. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence. Although a network device (e.g., using the system-on-chip (SoC) 700 or a hardware component such as an FPGA or ASIC, etc.) is described as performing the method, this example is for descriptive purposes.

At block 602, the network device may receive first frames from a first path and receive second frames from a second path. For example, the network device may include a first network interface connected to the first path and a second network interface connected to the second path. In this example, it is presumed that the first frames are received before the second frames. In one example, the first path comprises a first local area network, and the second path comprises a second local area network. In another example, first path comprises a first direction around a ring network and the second path comprises a second direction around a network.

At block 604, the network device may determine a network performance imbalance between a redundancy edge device to the network device based on receiving the first frames and the second frames. For example, a path mismatch device in the network device may be configured to determine the network performance of both network paths.

In one example of block 604, the path mismatch device is configured to determine at least a first network metric of the first path through a first set of nodes to the network device and determine at least a second network metric of the second path through a second set of nodes to the network device. Non-limiting examples of the first (or second) network metric include at least one of a bandwidth, a standard deviation of delay, latency, and jitter. In this example, the path mismatch device predicts a time that the threshold of memory will be consumed based on the first frames that have been received at the network device from the first path using the first network metric and the second network metric. For example, if the time is within 60 seconds, the path mismatch device identifies a potential condition that can cause the network device performance integrity to fail by exceeded memory capacity, causing information to be dropped.

In another example of block 604, the path mismatch device may be configured to determine that the threshold of memory is consumed based on the first frames that have been received at the network device from the first path. In this case, the corresponding second frames have not been received from the second path and there is a network imbalance.

At block 606, the network device may, in response to determining a threshold of memory will be exceeded based on a delay between the first frames and the second frames, provide an indication to slow frames transmitted along the first path.

In one aspect, the path mismatch device may be configured to transmit the indication to the redundancy edge device that duplicates original frames into the first frames and the second frames. In this example, the redundancy edge device configures a buffer to delay transmission of the first frames in response to the indication.

In another aspect, the path mismatch device may be configured to insert a congestion indication into a packet within frames transmitted from the network device to a destination network device. In this example, the destination network device receives the congestion indication and requests a transmitting device to reduce transmission of content.

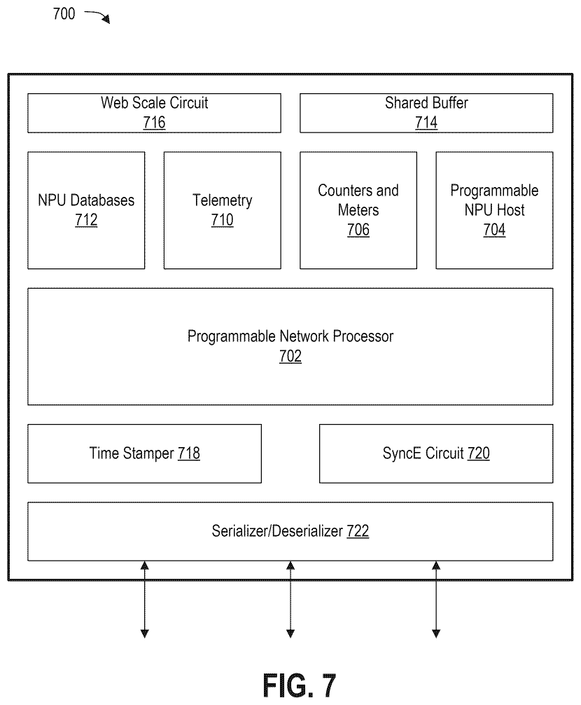

FIG. 7 illustrates a block diagram of an SoC 700 in a network device to perform various functions in hardware in accordance with various aspects of the disclosure. For example, the SoC 700 may include fixed hardware components and programmable hardware components to perform various network tasks. In one illustrative aspect, the SoC 700 includes a programmable network processor 702 (e.g., a network processing unit (NPU), etc.), a programmable NPU host 704, counters and meters 706, telemetry 710, an NPU database 712, a shared buffer 714, a web scale circuit 716, a time stamper 718, a synchronous Ethernet (SyncE) circuit 720, and a serializer/deserializer 722. In some cases, the SoC 700 may be configured to execute bytecode instructions to be supplemented with additional functions. For example, the SoC 700 may be configured to execute various functions described above, and may include hardware support for a network mismatch device at Layer 2.

The programmable network processor 702 may be programmed to perform functions that are conventionally performed by integrated circuits (IC) that are specific to switching, routing line card, and routing fabric. The programmable network processor 702 may be programmable using the programming protocol-independent packet processors (P4) language, which is a domain-specific programming language for network devices for processing packets. The programmable network processor 702 may have a distributed P4 NPU architecture that may execute at a line rate for small packets with complex processing. The programmable network processor 702 may also include optimized and shared NPU fungible tables. In some aspects, the programmable network processor 702 supports a unified software development kit (SDK) to provide consistent integrations across different network infrastructures and simplifies networking deployments. The SoC 700 may also include embedded processors to offload various processes, such as asynchronous computations.

The programmable network processor 702 includes a programmable NPU host 704 that may be configured to perform various management tasks, such as exception processing and control-plane functionality. In one aspect, the programmable NPU host 704 may be configured to perform high-bandwidth offline packet processing such as, for example, operations, administration, and management (OAM) processing and MAC learning.

The SoC 700 includes counters and meters 706 for traffic policing, coloring, and monitoring. As an example, the counters and meters 706 include programmable counters used for flow statistics and OAM loss measurements. The programmable counters may also be used for port utilization, microburst detection, delay measurements, flow tracking, elephant flow detection, congestion tracking, etc.

The telemetry 710 is configured to provide in-band telemetry information such as per-hop granular data in the forwarding plane. The telemetry 710 may observe changes in flow patterns caused by microbursts, packet transmission delay, latency per node, and new ports in flow paths. The NPU database 712 provides data storage for one or more devices, for example, the programmable network processor 702 and the programmable NPU host 704. The NPU database 712 may include different types of storage, such as key-value pair, block storage, etc.

In some aspects, the SoC 700 includes a shared buffer 714 that may be configured to buffer data, configurations, packets, and other content. The shared buffer 714 may be utilized by various components such as the programmable network processor 702 and the programmable NPU host 704. A web scale circuit 716 may be configured to dynamically allocate resources within the SoC 700 for scale, reliability, consistency, fault tolerance, etc.

In some aspects, the SoC 700 may also include a time of day (ToD) time stamper 718 and a SyncE circuit 720 for distributing a reference to subordinate devices. For example, the time stamper 718 may support IEEE-1588 for ToD functions. In some aspects, the time stamper 718 includes support for a precision timing protocol (PTP) for distributing frequency and/or phase to enable subordinate devices to synchronize with the SoC 700 for nano-second level accuracy.

The serializer/deserializer 722 is configured to serialize and deserialize packets into electrical signals and data. In one aspect, the serializer/deserializer 722 supports sending and receiving data using non-return-to-zero (NRZ) modulation or pulse amplitude modulation 4-level (PAM4) modulation. In one illustrative aspect, the hardware components of the SoC 700 provide features for terabit-level performance based on flexible port configuration, nanosecond-level timing, and programmable features. Non-limiting examples of hardware functions that the SoC 700 may support include IP tunneling, multicast, network address translation (NAT), port address translation (PAT), security and quality of service (QoS) access control lists (ACLs), equal cost multiple path (ECMP), congestion management, distributed denial of service (DDos) migration using control plane policing, telemetry, timing and frequency synchronization, and so forth.

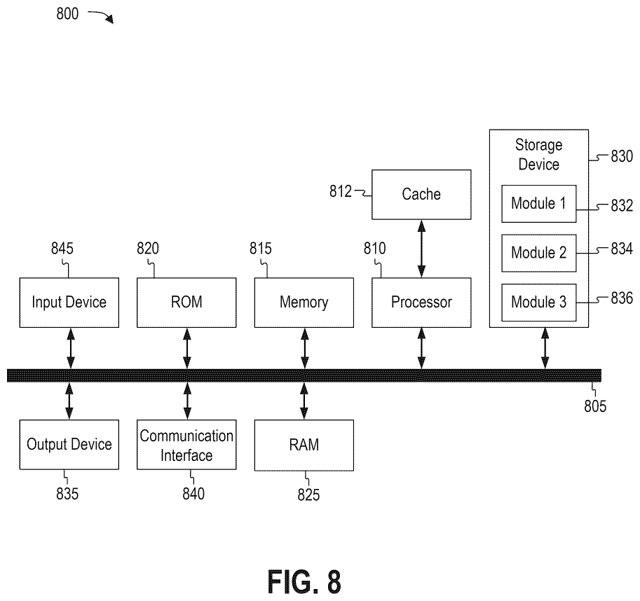

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 800 includes at least one processing unit (a central processing unit (CPU) or processor) 810 and connection 805 that couples various system components including system memory 815, such as ROM 820 and RAM 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., method 600, and/or other process described herein) may be performed by a computing device or apparatus. In one example, the method 600 can be performed by a computing device having a computing architecture of the computing system 800 shown in FIG. 8.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth^{TM} standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, graphical processing units (GPUs), digital signal processors (DSPs), CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an ASIC, FPGAs, or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method of a redundancy receiver for balancing replicated frames, comprising:
receiving, at a redundancy receiver, first frames from a first path and second frames from a second path;
determining a network performance imbalance between a redundancy edge device to the redundancy receiver based on receiving the first frames and the second frames; and
in response to determining a threshold of memory will be exceeded based on a delay between the first frames and the second frames, providing an indication to slow frames transmitted along the first path.

2. The method of claim 1, wherein providing the indication to slow the frames transmitted along the second path comprises:
transmitting the indication to the redundancy edge device that duplicates original frames into the first frames and the second frames, wherein the redundancy edge device configures a buffer to delay transmission of the first frames in response to the indication.

3. The method of claim 1, wherein providing an indication to slow the frames transmitted along the second path comprises:
inserting a congestion indication into a packet within frames transmitted from the redundancy receiver to a network device, wherein the network device receives the congestion indication and requests a transmitting device to reduce transmission of content.

4. The method of claim 1, wherein determining the network performance imbalance comprises:
determining at least a first network metric of the first path through a first set of nodes to the redundancy receiver; and
determining at least a second network metric of the second path through a second set of nodes to the redundancy receiver.

5. The method of claim 4, further comprising:
predicting a time that the threshold of memory will be consumed based on the first frames that have been received at the redundancy receiver from the first path using the first network metric and the second network metric.

6. The method of claim 4, wherein the first network metric includes at least one of a bandwidth, a standard deviation of delay, latency, and jitter.

7. The method of claim 1, wherein determining the network performance imbalance comprises:
determining that the threshold of memory is consumed based on the first frames that have been received at the redundancy receiver from the first path, wherein the corresponding second frames have not been received from the second path.

8. The method of claim 1, wherein the first frames are received before the second frames.

9. The method of claim 1, wherein the first path comprises a first local area network, and the second path comprises a second local area network.

10. The method of claim 1, wherein the first path comprises a first direction around a ring network and the second path comprises a second direction around a network.

11. A network device for performing a function, comprising:
at least one memory;
a first network interface configured to receive first frames from a first path;
a second network interface configured to receive second frames from a second path; and
a path mismatch device configured to:
determine a network performance imbalance between a redundancy edge device to the network device based on receiving the first frames and the second frames; and
in response to determining a threshold of memory will be exceeded based on a delay between the first frames and the second frames, provide an indication to slow frames transmitted along the first path.

12. The network device of claim 11, wherein the path mismatch device is configured to:
transmit the indication to the redundancy edge device that duplicates original frames into the first frames and the second frames, wherein the redundancy edge device configures a buffer to delay transmission of the first frames in response to the indication.

13. The network device of claim 11, wherein the path mismatch device is configured to:
insert a congestion indication into a packet within frames transmitted from the network device to a destination network device, wherein the destination network device receives the congestion indication and requests a transmitting device to reduce transmission of content.

14. The network device of claim 11, wherein the path mismatch device is configured to:
determine at least a first network metric of the first path through a first set of nodes to the network device; and
determine at least a second network metric of the second path through a second set of nodes to the network device.

15. The network device of claim 14, wherein the path mismatch device is configured to:
predict a time that the threshold of memory will be consumed based on the first frames that have been received at the network device from the first path using the first network metric and the second network metric.

16. The network device of claim 14, wherein the first network metric includes at least one of a bandwidth, a standard deviation of delay, latency, and jitter.

17. The network device of claim 11, wherein the path mismatch device is configured to:
determine that the threshold of memory is consumed based on the first frames that have been received at the network device from the first path, wherein the corresponding second frames have not been received from the second path.

18. The network device of claim 11, wherein the first frames are received before the second frames.

19. The network device of claim 11, wherein the first path comprises a first local area network, and the second path comprises a second local area network.

20. The network device of claim 11, wherein the first path comprises a first direction around a ring network and the second path comprises a second direction around a network.
